(19) United States
(12) Patent Application Publication
(10) Pub. No.: US 2008/0110991 A1
(43) Pub. Date: May 15, 2008

(54) APPARATUS AND METHODS FOR PROVIDING ACTIVE FUNCTIONS USING ENCODED TWO-DIMENSIONAL ARRAYS

(75) Inventor: James Carlton Bedingfield, Lilburn, GA (US)

Correspondence Address: MYERS BIGEL SIBLEY & SAJOVEC, P.A., P.O. BOX 37428, RALEIGH, NC, 27627, US

(73) Assignee: BellSouth Intellectual Property Corporation

(21) Appl. No.: 11/560,012

(22) Filed: Nov. 15, 2006

(51) Int. Cl. G06K 7/10

(52) U.S. Cl. 235/462.1

(57) ABSTRACT

Embodiments of the present invention provide apparatus and/or methods for providing interactive functionality using a two-dimensional coded array. Some embodiments can include a reader configured to receive coded data from the two-dimensional coded array and a display configured to display an active menu corresponding to data content of the coded data.

### FIELD OF THE INVENTION

This invention relates to electronic apparatus and methods, and, more particularly, to apparatus and methods for providing improved system access and functionality.

### BACKGROUND OF THE INVENTION

Communicating information through the use of machine readable arrays can provide advantages in a variety of applications. For example, barcodes are one-dimensional arrays that can be used to convey numerical information to a reader. Such information, can include, for example, a product identification number, price, and/or location, among others. Barcodes, however, can generally lack the informational capacity to provide significant quantities of data and thus can be limited in practical application.

In this regard, two-dimensional barcodes or arrays can be used to increase the informational capacity of a code. For example, Semacode provides machine readable data matrix symbols as defined in standard ISO/IEC 16022 for encoding internet Uniform Resource Locators (URLs). Under the Semacode standard, a URL can be converted into a type of two-dimensional barcode, which is called a tag. A tag can be easily captured using, for example, a video capture device and decoded to obtain a web site address. Other than providing information, such as an address, however, such codes can be generally limited in application.

### SUMMARY OF THE INVENTION

Embodiments of the present invention provide apparatus and/or methods for providing interactive functionality using a two-dimensional coded array. Methods in accordance with some embodiments can include capturing the two-dimensional coded array as an image in an electronic device using a video capture component. The captured image can be decoded to determine the array data content and an active menu corresponding to the array data content can be displayed in the electronic device. In some embodiments, the array data content can include menu population data configured to populate a pre-defined menu structure. In further embodiments, the array data content can include menu format data and menu content data.

In yet further embodiments, the array data can include an address corresponding to a data storage location that includes menu data. In some embodiments, menu data can be received into the electronic device from the data storage location in response to the array data content.

In further embodiments, computer program product that can include computer-readable program code embodied on a computer-readable medium can be configured to carry out methods for providing interactive functionality using a two-dimensional coded array.

In yet further embodiments, the array data content can include executable code that can be executed within the electronic device. In some embodiments, the executable code can activate a function in an entertainment system.

In some embodiments, a command corresponding to an action option on the menu can be transmitted from the electronic device to an external system.

Some embodiments can include electronic devices for providing interactive functionality using a two-dimensional coded array. Such devices can include a reader that can receive coded data from the two-dimensional coded array and a display configured to display an active menu corresponding to data content of the coded data.

In some embodiments, devices can include an image interpreter configured to determine the data content from the two-dimensional coded array, wherein the reader can include a video capture device and the two dimensional coded array can be an image. In further embodiments, the reader can include a conductive reader configured to receive the coded data through electrical conduction and the two-dimensional coded array can include multiple electrically conductive points.

Yet further embodiments can include a processor configured to process executable code contained in the coded data corresponding to an interactive application configured to provide as active menu for display.

In some embodiments, devices can include a communication module configured to receive data corresponding to menu content from an external system, wherein the coded data can include an address corresponding to the external system.

In some other embodiments, a communication module can be included that can transmit data corresponding to a selected menu option to an external system.

In further embodiments, the data content of the coded data can include menu fill data for populating a predefined menu structure. In yet further embodiments, the data content of the coded data can include menu structure data, menu format data, and menu fill data.

Some embodiments can include an electronic device for providing interactive functionality using a two-dimensional coded array. Such devices according to some embodiments can include a reader configured to read the two-dimensional coded array, an array processor configured to determine data content of the two-dimensional coded array and to execute an application included in the data content, and a communication module configured to send a command to an external device that performs an action responsive to the command.

Some embodiments can include a display configured to display a menu corresponding to available functions in the external device. Further embodiments can include a memory that can store multiple menu formats that can be selected and populated by the data content of the two-dimensional coded array.

Other systems, methods, and/or apparatus according to embodiments will be or become apparent to one with skill in the art upon review of the following drawings and detailed description. It is intended that all such additional systems, methods, and/or apparatus be included within this description, be within the scope of the present invention, and be protected by the accompanying claims.

### BRIEF DESCRIPTION OF THE DRAWINGS

FIG. 1 is a block diagram illustrating functional components in methods/apparatus for providing interactive functionality using a two-dimensional coded array according to some embodiments of the present invention.

FIG. 2 is a block diagram illustrating functional components in methods/apparatus for providing interactive functionality using a two-dimensional coded visually readable array according to some embodiments of the present invention.

FIG. 3 is a block diagram illustrating functional components for providing interactive functionality using a two-dimensional coded array according to some embodiments of the present invention.

FIG. 4 is a block diagram illustrating functional components in methods/apparatus for providing interactive functionality using a two-dimensional coded array according to some other embodiments of the present invention.

FIG. 5 is a side cut-away diagram illustrating a conductive reader and two-dimensional coded array according to some embodiments of the present invention.

FIG. 6 is a flow diagram illustrating operations for providing interactive functionality using a two-dimensional coded array according to some embodiments of the present invention.

FIG. 7 is a flow diagram illustrating operations for providing interactive functionality using a two-dimensional coded array according to some other embodiments of the present invention.

FIG. 8 is a flow diagram illustrating operations for providing interactive functionality using a two-dimensional coded array and an external system according to some embodiments of the present invention.

### DETAILED DESCRIPTION

The present invention now will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” to another element, it can be directly responsive to the other element, or intervening elements may be present. In contrast, when an element is referred to as being “directly responsive” to another element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another.

The present invention is described below with reference to block diagrams and/or flowchart illustrations of methods, apparatus (systems and/or devices) and/or computer program products according to embodiments of the invention. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

Some embodiments of the present invention may arise from a recognition that it may be desirable to provide interactive functionality using a two-dimensional coded array. In particular, active menus corresponding to the array may be useful to provide interactive functionality between a user and a system. The menus can be displayed in a device that captures the array as an image and interprets the captured image to determine the array content.

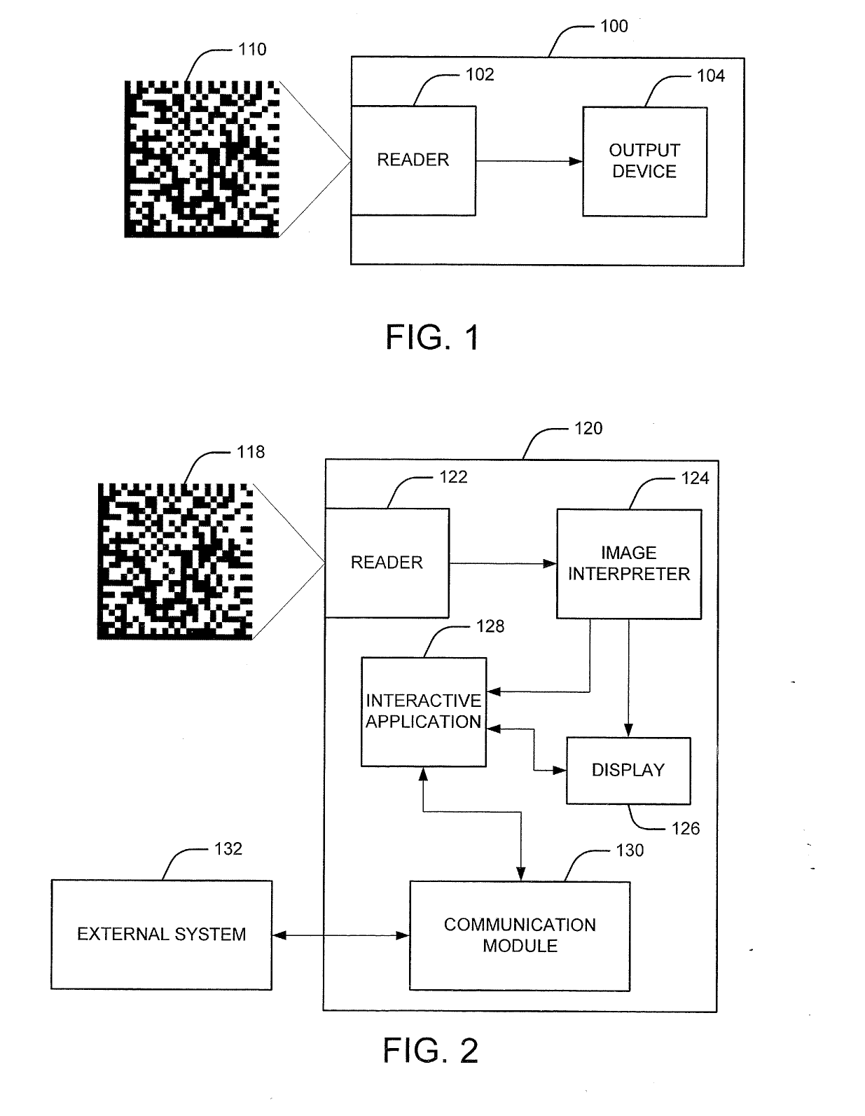

Reference is now made to FIG. 1, which is a block diagram illustrating functional components in methods/apparatus for providing interactive functionality using a two-dimensional coded array according to some embodiments of the present invention. Some embodiments can include an electronic device 100 that includes a reader 102 that can read the contents of a two-dimensional coded array 110 into the electronic device 100. In some embodiments, the reader 102 can be a video capture device that can capture a visually readable array. For example, the array 110, as illustrated, can include a black and white pixelated image having a pattern of white and black areas that convey coded information. Other embodiments can include an array constructed of conductive points having a variety of relative electrical properties that are configured to convey coded information. In this regard, the reader 102 can be configured to contact the surface of the array 110 with a series of conductive pins to determine the pattern of the array.

An electronic device of some embodiments can also include an output device 104 configured to output an active menu corresponding to the coded data of the array 110. In some embodiments, the output device 104 can be a display, an audio output device and/or a tactile output device. The coded data can include a small number of characters at the beginning of the code that signals the electronic device 100 regarding the type of menu or action that can be displayed or performed. In some embodiments the coded data can include complete menu information such as menu structure, menu format, and menu fill data. In this regard, the coded data can include a variety of menu supported actions, menu content, and/or menu presentations. In some embodiments, the coded data can include executable code for processing within the electronic device 100. In further embodiments, the coded data can be encrypted by using, for example, public key and/or private key encryption techniques.

Reference is now made to FIG. 2, which is a block diagram illustrating functional components in methods/apparatus for providing interactive functionality using a two-dimensional coded visually readable array according to some embodiments of the present invention. In some embodiments, functional components can include an electronic device 120. The electronic device 120 can include a reader 122 configured to read a two-dimensional visually readable coded array 118. The array 118 can include a specific combination of high contrast regions that, in combination, can represent values, characters, and or codes in, for example a binary system. In some embodiments, the array 118 can include multiple colors and/or levels of contrast to increase the informational content per pixel.

The electronic device 120 can also include an image interpreter 124 configured to determine the data content of the array 118. In some embodiments, the image interpreter 124 can be included in an external system 132, such that the image data is communicated to the external system 132 where the array data content can be determined and communicated to the electronic device 120. The image interpreter 124 can provide data content information to a display 126 in the electronic device 120. The data content information can also be sent to an interactive application 128 that can be configured to provide interactive functionality for a user. Output of the display 126 can be modified responsive to user input as processed in the interactive application 128. In some embodiments, the interactive application 128 can receive executable code that can be included in the image data content.

The interactive application 128 can perform actions in an external system 132 via a communication module 130. In some embodiments, actions can include selecting a channel in an entertainment system responsive to reading an array 118 that corresponds to a listing in a program guide. An exemplary action can also include scheduling and/or activating a recording device to record an event or show corresponding to a listing. In further embodiments, an action can be purchasing, inquiring, and/or configuring a product and/or process through options provided in an active menu. In yet further embodiments, an action can include storing data in a calendar and/or address book. In some embodiments, an electronic device 120 can be configured to perform an action, such as scheduling a recording, without displaying a menu. A communication module 130 can include wireless and/or wired communication components. The external system 132 can include an entertainment system and/or component, a store inventory control system and/or component, a purchasing system and/or component, server, and/or computer configured to communicate with the electronic device, among others.

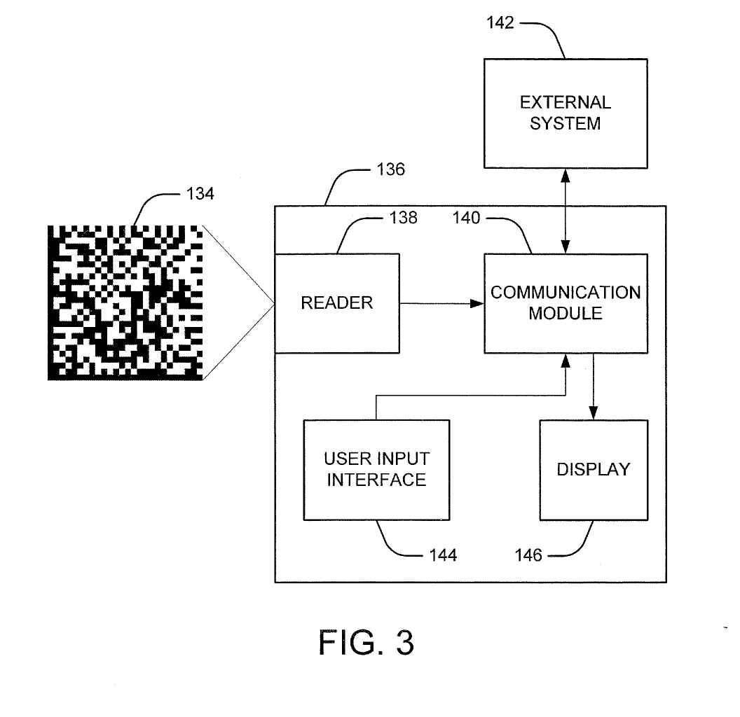

Reference is now made to FIG. 3, which is a block diagram illustrating functional components for providing interactive functionality using a two-dimensional coded array according to some embodiments of the present invention. Some embodiments can include an electronic device 136 that can include a reader 138 configured to read a two-dimensional coded array 134. The array 134 can be configured as an image for receipt via a video capture device and/or component and/or a conductive surface configured to be read by a conductive reader. The array can also be a magnetically encoded machine readable surface configured to be read by a magnetic and/or inductive reader.

The reader 138 can read the array 134 and transmit the array data to a communication module 140. The communication module 140, which can use wired and/or wireless communication technology, can transmit the array data to an external system 142. The external system 142 can include functionality to interpret the array data and can transmit menu and/or action data back to the electronic device 136 via the communication module 140. Menu and/or action data can be sent to the display 146 for access by a user. In some embodiments, the user can select actions from a displayed menu using a user input interface 144. The actions selected by the user can be sent to the external system 142 via the communication module 140. A user input interface 144 can include one or more switches, buttons, touch-screens, pointers, and/or styli, among others. In some embodiments, the actions or selections are triggered when the data from the array 134 is captured and transmitted to the external system 142 without any additional input from the user.

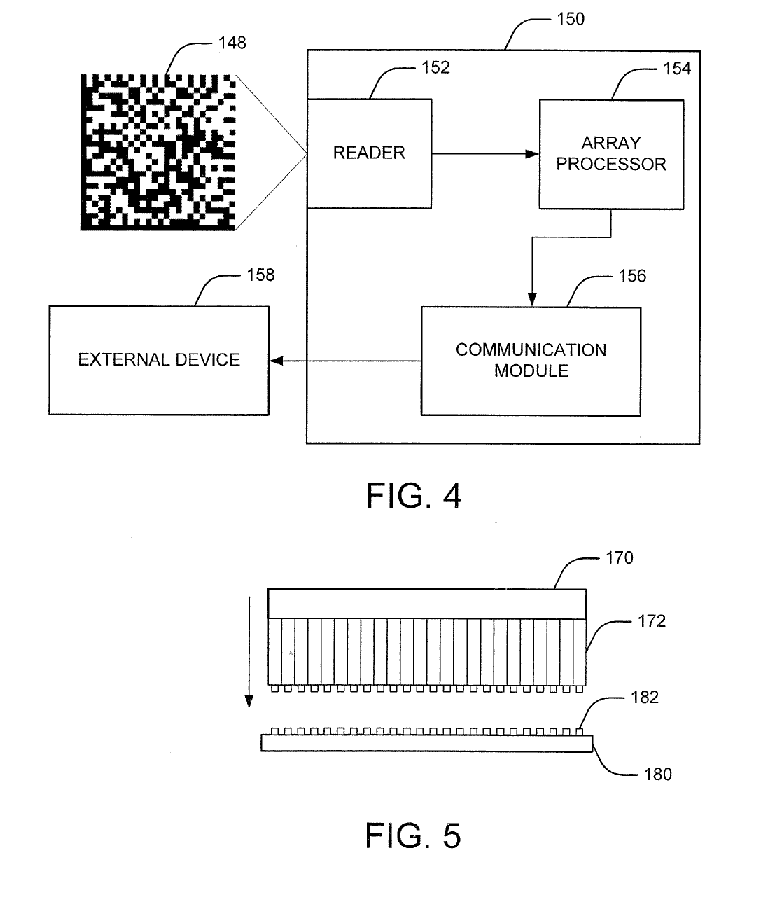

Reference is now made to FIG. 4, which is a block diagram illustrating functional components in methods/apparatus for providing interactive functionality using a two-dimensional coded array according to some embodiments of the present invention. Functional components in some embodiments can include an electronic device 150 configured to read a two-dimensional coded array 148 using a reader 152. After receiving the array data, the reader 152 transmits the array data to an array processor 154 configured to determine the information content of the coded array. In some embodiments, the information content directs an action that can be communicated to an external device 158 via a communication module 156. For example, the array may be in a commercial premises or catalog and correspond to a particular product and/or merchandise. By reading the array 148, the electronic device 150 may cause the external device to add the corresponding item to a purchase list, such as a gift registry.

Reference is now made to FIG. 5, which is a side cut-away diagram illustrating a conductive reader and two-dimensional coded array according to some embodiments of the present invention. In some embodiments, a reader 170 can include multiple electrically conductive pins 172 that are configured to conductively interface with electrically conductive array points 182 on a two-dimensional coded array 180. The conductive points 182 can be used to provide an encoded data pattern using distinctions in electrical properties including voltage, current and/or resistance, among others. In some embodiments, the reader 170 and the array 180 can further include alignment mechanisms such as pins, dividers, and/or sidewalls, among others. Some embodiments can include a reader having a plurality of electrical induction sensors corresponding to points of a two-dimensional coded array.

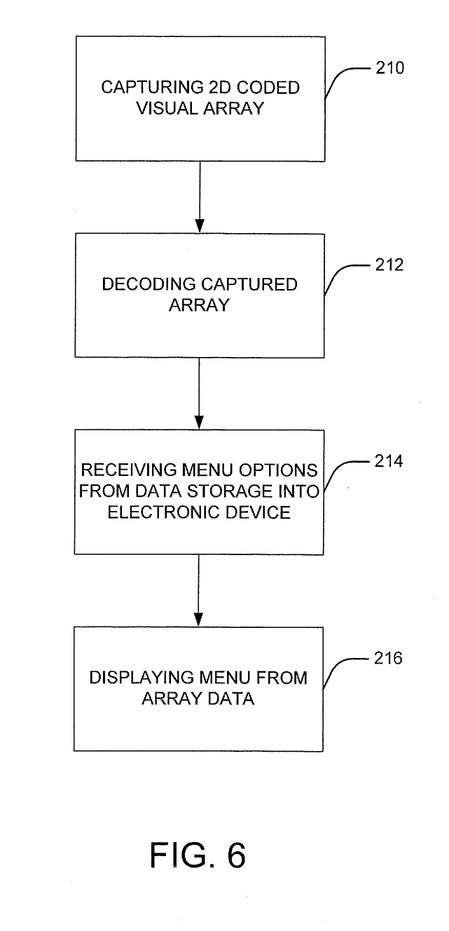

Reference is now made to FIG. 6, which is a flow diagram illustrating operations for providing interactive functionality using a two-dimensional coded array according to some embodiments of the present invention. The operations can include capturing a two-dimensional coded visual array (block 210) into an electronic device. The array can be captured using, for example, video image capturing technology, as is used in a variety of video capture devices and/or components. The captured array image is decoded (block 212) to determine the array data content. In some embodiments, the array data includes an address corresponding to a data storage location that includes active menu and/or action data. The menu and/or action options can be received from data storage into the electronic device (block 214). An active menu corresponding to the array data can be displayed by the electronic device (block 216). In some embodiments, an action can be triggered by executable code within the array data and/or an active menu can be displayed.

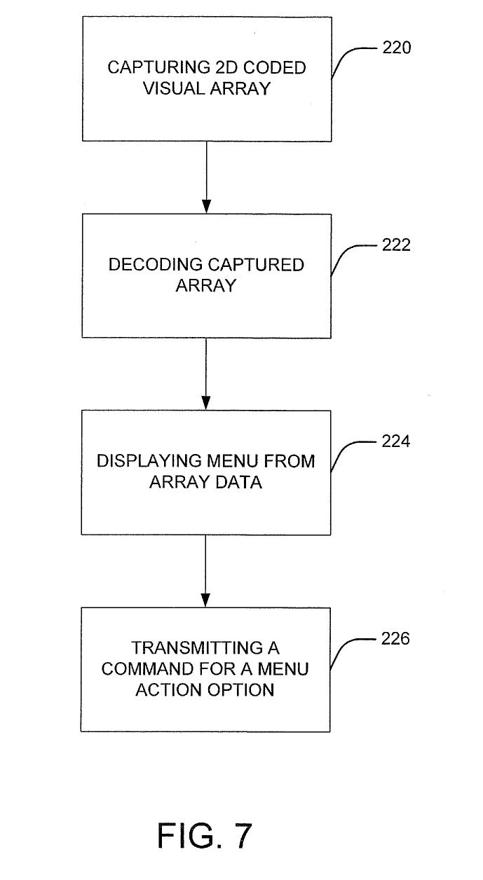

Reference is now made to FIG. 7, which is a flow diagram illustrating operations for providing interactive functionality using a two-dimensional coded array according to some other embodiments of the present invention. In some embodiments, operations can include capturing an image of a two-dimensional coded visually readable array (block 220) into an electronic device. The data content of the array can be determined by decoding the captured array image (block 222). An active menu that corresponds to the array data content can be displayed (block 224). In some embodiments, the array can include an indication as to what predefined menu format to use. In this manner, the array content can include fill data for populating the predefined menu structure. In some embodiments, the array data content can include menu format and menu fill data such that the format and structure are determined solely by the content of the array. In some embodiments, the array content can include a remote data storage address that can contain menu fill and/or menu format data. In this manner, the electronic device can receive the menu fill and/or format data from the remote data storage location. A command corresponding to a menu action option can be transmitted from the electronic device to a remote and/or external system for performing an action (block 226). In some embodiments, the array data can include executable code configured to execute one or more functions responsive to the decoding of the array data.

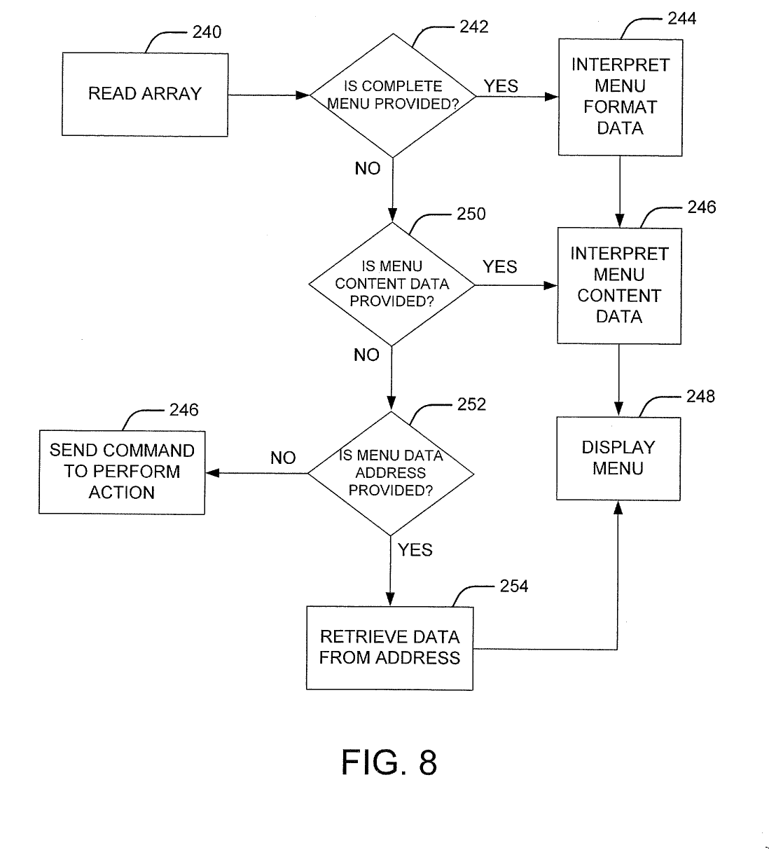

Reference is now made to FIG. 8, which is a flow diagram illustrating operations for providing interactive functionality using a two-dimensional coded array and an external system according to some embodiments of the present invention. In the operations of some embodiments, a two-dimensional coded data array is read (block 240). An introductory code can provide signals as to whether a complete menu is provided (block 242). A complete menu can include menu format and content information such that the array includes the format and menu content information or fill data used to generate the menu without data or information from other data sources. If the complete menu is provided in the array, the menu format data is interpreted (block 244). After and/or while interpreting the menu format data, the menu content data can be interpreted (block 246). The menu can then be displayed (block 248).

If the complete menu is not provided in the array, the introductory code can signal whether the menu content is provided in the array (block 250). If the menu content is provided in the array then the menu content can be interpreted (block 246) in the context of a predefined and/or default menu format. The menu can be then displayed using the predefined format and the interpreted menu content (block 248). If the menu content is not provided in the array, introductory code can signal whether a menu data storage address is provided (block 252). If a menu data storage address is provided, the menu data can be retrieved from the address (block 254). The menu can be displayed using the retrieved menu data, which can include menu format and/or menu content data (block 248). If a menu data address is not signaled in the introductory code, then a command contained within the array data or at the data storage address can be sent to perform an action (block 246). In this manner, a single device can utilize multiple types of external systems having multiple configurations and capabilities. For example, a device used to facilitate purchases in a commercial environment can also be used to trigger the channel change of a television. The same device can further be configured to provide active menus to a professional in a specific setting such as a medical care environment.

In the drawings and specification, there have been disclosed typical embodiments of the invention and, although specific terms are employed, they are used in a generic and descriptive sense only and not for purposes of limitation, the scope of the invention being set forth in the following claims.

What is claimed is:

1. A method of providing interactive functionality using a two-dimensional coded visually readable array, the method comprising:
capturing the two-dimensional coded array as an image in an electronic device using a video capture component;
decoding the captured image to determine array data content; and
displaying, in the electronic device, an active menu corresponding to the array data content.

2. The method of claim 1, wherein the array data content comprises menu population data configured to populate a pre-defined menu structure.

3. The method of claim 1, wherein the array data content comprises menu format and menu fill data.

4. The method of claim 1, wherein the array data comprises an address corresponding to a data storage location that includes menu data.

5. The method of claim 4, further comprising receiving menu data from the data storage location to the electronic device responsive to the array data content.

6. A computer program product comprising computer-readable program code embodied on a computer-readable medium, the computer readable program code being configured to carry out the method of claim 1.

7. The method of claim 1, wherein the array data content comprises executable code that can be executed within the electronic device.

8. The method of claim 7, wherein the executable code is configured to activate a function in an entertainment system.

9. The method of claim 1, further comprising transmitting a command corresponding to an action option on the menu from the electronic device to an external system.

10. An electronic device for providing interactive functionality using a two-dimensional coded array, the device comprising:
a reader configured to receive coded data from the two-dimensional coded array; and
an output device configured to display an active menu corresponding to data content of the coded data.

11. The device of claim 10, further comprising an image interpreter configured to determine the data content from the two-dimensional coded array, wherein the reader comprises a video capture device and the two dimensional coded array comprises an image.

12. The device of claim 10, wherein the reader comprises a conductive reader configured to receive the coded data through electrical conduction and the two-dimensional coded array comprises a plurality of electrically conductive points.

13. The device of claim 10, further comprising a processor configured to process executable code contained in the coded data corresponding to an interactive application configured to provide as active menu for output.

14. The device of claim 10, further comprising a communication module configured to receive data corresponding to menu content from an external system, wherein the coded data comprises an address corresponding to the external system.

15. The device of claim 10, further comprising a communication module configured to transmit data corresponding to a selected menu option to an external system.

16. The device of claim 10, wherein the data content of the coded data comprises menu fill data for populating a predefined menu structure.

17. The device of claim 10, wherein the data content of the coded data comprises menu structure data, menu format data, and menu fill data.

18. An electronic device for providing interactive functionality using a two-dimensional coded array, the device comprising:
a reader configured to read the two-dimensional coded array;
an array processor configured to determine data content of the two-dimensional coded array and to execute an application included in the data content; and
a communication module configured to send a command to an external device that performs an action responsive to the command.

19. The device of claim 18, further comprising a display configured to display a menu corresponding to available functions in the external device.

20. The device of claim 19, further comprising a memory configured to store a plurality of menu formats configured to be selected and populated by the data content of the two-dimensional coded array.
